(19) United States
(12) Patent Application Publication
(10) Pub. No.: US 2023/0131348 A1
(43) Pub. Date: Apr. 27, 2023

(54) FLEXIBLE HIERARCHICAL KEY MANAGEMENT MODEL

(71) Applicant: Entrust Corporation, Shakopee, MN (US)

(72) Inventors: KENT LANDERHOLM, Apple Valley, MN (US); EVAN VAALA, Eden Prairie, MN (US); RICHARD KETTLEWELL, Cambridge (GB)

(73) Assignee: Entrust Corporation, Shakopee, MN (US)

(21) Appl. No.: 17/973,112

(22) Filed: Oct. 25, 2022

Related U.S. Application Data
(60) Provisional application No. 63/271,479, filed on Oct. 25, 2021.

(51) Int. Cl. H04L 9/08; H04L 9/32

(52) U.S. Cl. CPC H04L 9/0877; H04L 9/0825; H04L 9/3213

(57) ABSTRACT

Systems and methods for managing cryptographic tokens within a hardware security module are disclosed. A parent cryptographic token contains a plurality of parent cryptographic objects, and a child cryptographic token contains a plurality of child cryptographic objects. The child cryptographic token is associated with the parent cryptographic token. A session established with the child token provides access to at least some of the plurality of child cryptographic objects and at least some the plurality of parent cryptographic objects.

### CROSS-REFERENCE TO RELATED APPLICATIONS

The present application claims priority from U.S. Provisional Patent Application No. 63/271,479, filed on Oct. 25, 2021, the disclosure of which is hereby incorporated by reference in its entirety.

### BACKGROUND

Hardware Security Modules (HSMs) are used to store secure cryptographic objects that may be used in secure applications, such as for credit card and/or passport issuance. Such HSMs are used to protect the confidentiality and integrity of secure cryptographic objects, such as secret keys and other sensitive objects. It is common practice to segregate cryptographic objects into tokens according to the ownership of those cryptographic objects. As an example, a service bureau that issues financial cards on behalf of several banks, or financial institutions may create a token for each bank/institution. The cryptographic objects associated with a specific bank are held in the corresponding token.

In such an arrangement, there also exist cryptographic objects that are owned at a higher level (such as by the service bureau itself, in the above example). It is often the case that these cryptographic objects would be present in all tokens associated with that service bureau. This may be at least in part because, for tokens that are securely managed within such a hardware security module, a particular client device that connects to the HSM may be limited in terms of which tokens and associated cryptographic objects may be accessed. Accordingly, a given token may contain cryptographic objects for a particular owner (e.g., the bank, in the above example), as well as cryptographic objects that are common across a number of tokens (e.g., those objects that are specific to a service bureau, in the above example).

In this arrangement, these cryptographic objects that are shared across tokens may be required to be changed, e.g., added, modified, or deleted. It can be difficult to make changes to keys, for example because key modifications require significant coordination among security officers associated with an organization to make such changes. When a change to a single cryptographic object owned at a higher level is required (e.g., in the event of key rotation), that change must be replicated across lower-level tokens, requiring to significant time and effort.

Still further, in instances where keys or other cryptographic objects are used by endpoints to assist in securing application data and secured at HSMs, it may be desirable for a particular HSM or HSMs to take on a role of managing policies associated with those cryptographic objects. This is particularly the case when cryptographic objects are distributed among HSMs, and avoids the requirement that such management would otherwise occur at the application level. Accordingly, improvements in management of such cryptographic objects are desirable.

### SUMMARY

In general, methods and systems for managing cryptographic tokens within a hardware security module are disclosed. In example aspects, cryptographic objects associated with different entities may be maintained within separate tokens and inherited across tokens, rather than having multiple entities' cryptographic objects contained within a single token, with some entities' cryptographic objects duplicated across tokens. Accordingly, changes to cryptographic objects may be made in one location, rather than across a plurality of tokens

In a first aspect, a system for managing cryptographic tokens within a hardware security module is disclosed. A parent cryptographic token contains a plurality of parent cryptographic objects, and a child cryptographic token contains a plurality of child cryptographic objects. The child cryptographic token is associated with the parent cryptographic token. A session established with the child token provides access to at least some of the plurality of child cryptographic objects and at least some the plurality of parent cryptographic objects.

In a second aspect, a method of managing tokens used at a hardware security module is disclosed. The method includes receiving a session connection request from a client associated with a child token, the child token containing a plurality of child cryptographic objects. The method also includes, in response to the session connection request, establishing a session with the child token, thereby providing access, via the session, to at least some of the plurality of child cryptographic objects and one or more parent cryptographic objects contained within a parent token associated with the child token.

In a third aspect, a system includes a parent cryptographic token stored in memory of a hardware security module (HSM), the parent cryptographic token containing a plurality of parent cryptographic objects. The system further includes a child cryptographic token stored in the memory, the child cryptographic token being associated with the parent cryptographic token and containing a plurality of child cryptographic objects. A session established with the child token provides access to at least some of the plurality of child cryptographic objects and at least some the plurality of parent cryptographic objects.

In a further aspect, a system for managing a policy associated with a cryptographic object within a hardware security module (HSM) is disclosed. The system includes a processing device and a memory operatively connected to the processing device and storing instructions which, when executed, cause the processing device to: generate a key blob associated with a key managed within the hardware security module, wherein, at the hardware security module, the key is associated with a policy comprising an access control list; and send the key blob to an inheriting hardware security module securely connected to the hardware security module via a key sending operation. The key sending operation includes an identification of a second access control list different from the access control list, the second access control list defining a policy associated with the key at the inheriting hardware security module.

### BRIEF DESCRIPTION OF THE DRAWINGS

The same number represents the same element or same type of element in all drawings.

FIG. 1 illustrates an example environment in which aspects of the present disclosure may be implemented.

FIG. 2 illustrates a conventional arrangement of tokens and cryptographic objects stored within a hardware security module.

FIG. 3 illustrates an updated, hierarchical arrangement of tokens and cryptographic objects within a hardware security module, in accordance with aspects of the present disclosure.

FIG. 4 is a flowchart of a method for accessing and establishing inheritance of a parent token by a first entity, in accordance with aspects of the present disclosure.

FIG. 5 is a flowchart of a method for accessing and establishing inheritance of a parent token at a client token by a second entity, in accordance with aspects of the present disclosure.

FIG. 6 is a flowchart of a method for accessing cryptographic objects by an entity associated with a child token, including inherited parent cryptographic objects, in accordance with aspects of the present disclosure.

FIG. 7 is a schematic diagram of a system for managing inheritance of cryptographic objects among tokens within a hardware security module, in accordance with aspects of the present disclosure.

FIG. 8 is a schematic diagram of a system for managing multiple inheritance cryptographic objects among tokens within a hardware security module, in accordance with aspects of the present disclosure.

FIG. 9 is an example computing system with which aspects of the present disclosure may be implemented.

FIG. 10 is a further example environment in which aspects of the present disclosure may be implemented.

FIG. 11 illustrates an example sequence of key and policy migration in which token hierarchy may be used to modify policy rates enforced at a hardware security module.

FIG. 12 is a flowchart of a method of migrating a key with a modified policy using the token hierarchy principles described herein.

### DETAILED DESCRIPTION

As briefly described above, embodiments of the present invention are directed to methods and systems for managing tokens in a hardware security module (HSM). In example aspects, a hierarchical structure may be used in which cryptographic objects (e.g., encryption keys or other objects) of a parent token may be inherited by a child token. In some embodiments, multiple inheritance, and conflict resolution among inherited cryptographic objects, are contemplated and resolved as well.

In accordance with the present disclosure, due to reduction in duplicate storage of cryptographic objects, overall storage requirements within an HSM are reduced. Additionally, computing resources and time required to perform management tasks with respect to such cryptographic objects, such as key rotation, addition, deletion, etc., are reduced because fewer resources would require modification.

In some example embodiments, the ability to control particular aspects of delegated cryptographic objects may be used in particular contexts such as when migrating a key across HSMs used to secure application level data. Such control over the manner in which policies in the form of, e.g., access control lists (ACLs), are associated with keys, provides a convenient way to allow HSMs to manage policies among distributed HSM arrangements within an organization.

### A. Environment and Hierarchical Token Arrangements

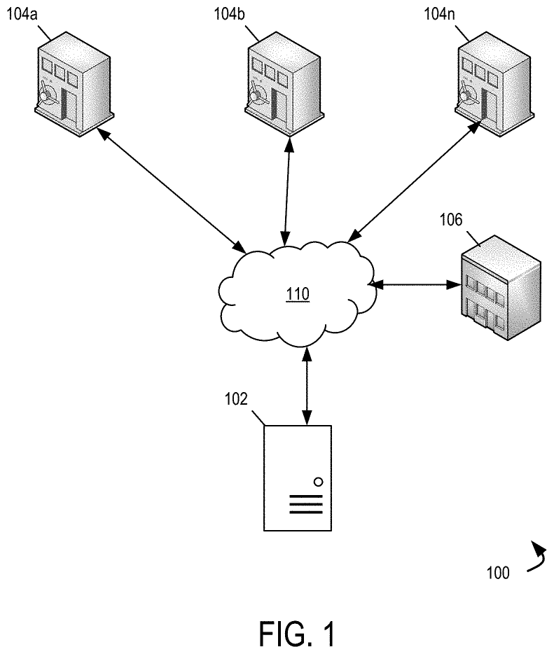

Referring first to FIG. 1, an example environment 100 is depicted in which aspects of the present disclosure may be implemented. In the example shown, a hardware security module (HSM) 102 is communicatively connected to a plurality of client institutions 104a-n (individually client institutions, or clients 104), via a network 110, such as the internet.

In general, the HSM 102 is a secure hardware device configured to securely store and manage cryptographic objects for a plurality of such clients 104. For example, the HSM may store tokens that contain cryptographic objects, such as security keys, for access by users at the client having sufficient security rights. In example applications, the clients may be banks, governmental institutions, or other clients who may wish to secure data with a third party HSM.

In addition to the clients 104, one or more secondary institutions 106 may be communicatively connected to the HSM 102. Although only one such institution is depicted for simplicity, it is understood that multiple such institutions may communicate with the HSM 102. The secondary institution 106 may be affiliated with multiple clients 104, and as such, tokens managed at the HSM 102 may be held by both clients 104 and secondary institutions 106. In an example instance of such a configuration, clients 104 may include banks or other financial institutions, and the secondary institutions 106 may include a service bureau or other card issuance entity acting on behalf of clients 104. Other arrangements are possible as well.

Generally, and as discussed in detail below, in circumstances where clients 104 may require coordination with one or more secondary institutions 106 (e.g., such as a service bureau as noted above), it is often the case that cryptographic objects associated with both entities are included within a single token that is associated with the client. In circumstances where multiple clients 104 are affiliated with one secondary institution 106, client tokens may have replicated across them cryptographic objects of the secondary institution 106.

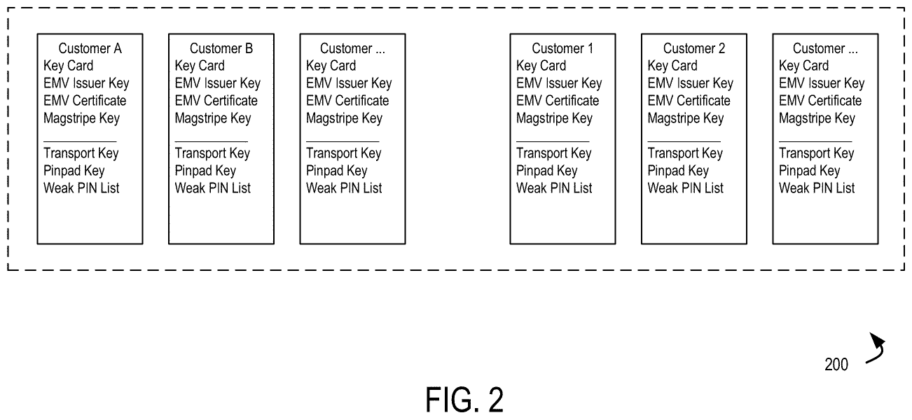

A particular example illustration of the above-described token organizational scheme for cryptographic objects is depicted in FIG. 2, which shows a conventional arrangement 200 of tokens and cryptographic objects. In that arrangement, a plurality of tokens are maintained within a storage location at a hardware security module, such as HSM 102. Each of the tokens may be associated with and accessible by a different client.

In the example shown, each token is associated with a particular client or customer, and includes cryptographic objects that are unique to that particular client and other cryptographic objects that are shared across a plurality of clients. In the example shown, a customer, such as “Customer A”, may have a set of unique cryptographic objects such as a key card key, an EMV issuer key, an EMV security key, and a magstripe key. Other types of keys that are specific to that client/customer are possible as well. These keys or other cryptographic objects are different from the corresponding objects associated with other clients/customers, such as “Customer B”, and so on.

Additionally, each token as shown in the arrangement 200 includes another set of cryptographic objects that are replicated across two or more tokens. Continuing the “Customer A” example above, a transport key, a pinpad key, a weak PIN list, and various other internal information may be shared across a set of customers. Notably, in the example above, Customer A, Customer B, etc. have a first set of common (replicated) cryptographic objects, and a second set of clients/customers including Customer 1, Customer 2, and so on may also each have unique cryptographic objects but may also have a second set of common cryptographic objects.

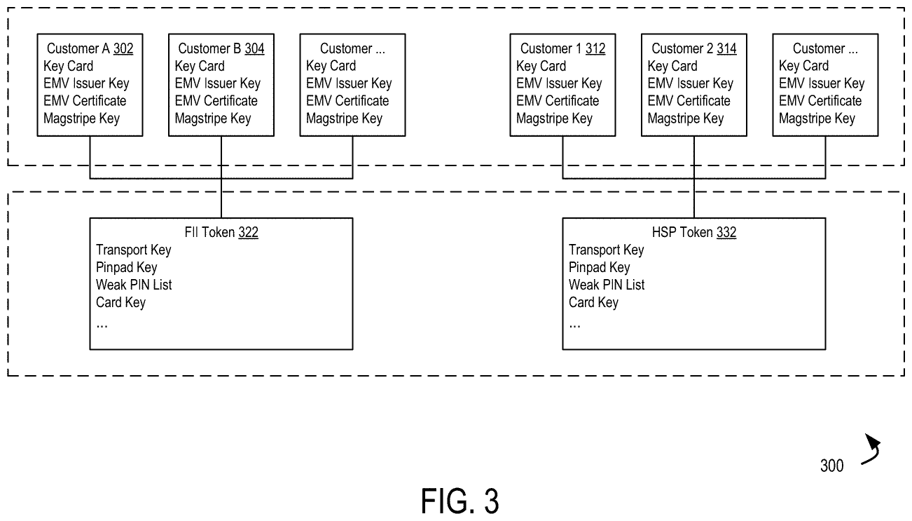

By way of comparison to the arrangement shown in FIG. 2, FIG. 3 illustrates an arrangement 300 in which a hierarchy or inheritance of cryptographic objects may be defined. In this example, a first token 302 owned by Customer A and a second token 304 owned by Customer B may each be associated, or linked, to a parent token 322 owned by another customer, such as a financial instant issuance service bureau. In this arrangement, the cryptographic objects that are specific to each customer may be maintained in that customer's token 302, 304, respectively; however, those cryptographic objects that would otherwise be duplicated across customer tokens are instead held in the parent token 322. Similarly, a different grouping of customers, e.g., Customer 1, Customer 2, etc., may have their own specific tokens 312, 314, respectively, and may share access to inherited cryptographic objects within a different parent token 332, shown as HSP Token.

In this context, each child token may include an identifier of one or more parent tokens from which it is capable of inheriting cryptographic objects; concurrently, each parent token may include an identifier of those child tokens granted access rights to cryptographic objects within that parent token. In this way, security is managed independently from the perspective of each entity.

As discussed in further detail below, although the tokens are arranged in the context of a single parent token and more than one child token, other arrangements are possible as well. For example, a single child token may be associated with a single parent token. In a further example, a child token may have more than one associated parent token from which it inherits and can access cryptographic objects. Still further, a parent token may in turn also be a child token, with that parent token inheriting/receiving access to cryptographic objects of a still further token, and potentially providing access to the client not only to those cryptographic objects of the parent token, but also those further inherited objects.

In embodiments in which a token inherits cryptographic objects from other tokens, and in particular where a token inherits cryptographic objects from multiple other tokens (e.g., referred to as parent, grandparent, etc., tokens herein) there is a possibility of conflict among cryptographic objects. Accordingly, as discussed below, methods and systems described herein provide methods for conflict resolution among objects. For example, where a child cryptographic token has a cryptographic object that conflicts with an object inherited from a parent token (e.g., the same key or key-type, or encryption configuration data), the child cryptographic object may be considered as controlling, and the parent cryptographic object discarded. Additionally, where a child obtains cryptographic objects from multiple parent tokens, the child token may include attributes defining an order of priority either among parent tokens generally, or among individual cryptographic objects.

It is noted that, in some embodiments, the above inheritance arrangement is further limited by the fact that client/customer devices seeking to access cryptographic objects stored in customer tokens in a hardware security module (e.g., HSM 102) does so in the context of a session in which that client/customer accesses cryptographic objects using an associated security context. That is, a customer device typically seeks to establish a session with the HSM, to access a particular cryptographic token, using a particular security context, such as a security officer context, a user context, a public context, or some other modifiable/custom security context. In examples, a security officer may only be able to access cryptographic objects associated with that security officer, and the user may only be able to access cryptographic objects associated with the user context. While there may be some overlap between the cryptographic objects associated with each security context, complete overlap is not typically the case, and therefore there may be some limitation as to which cryptographic objects are accessible at a particular client token based on the security context. This carries through to inheritance, with cryptographic objects inherited from a parent token also being limited based on security context.

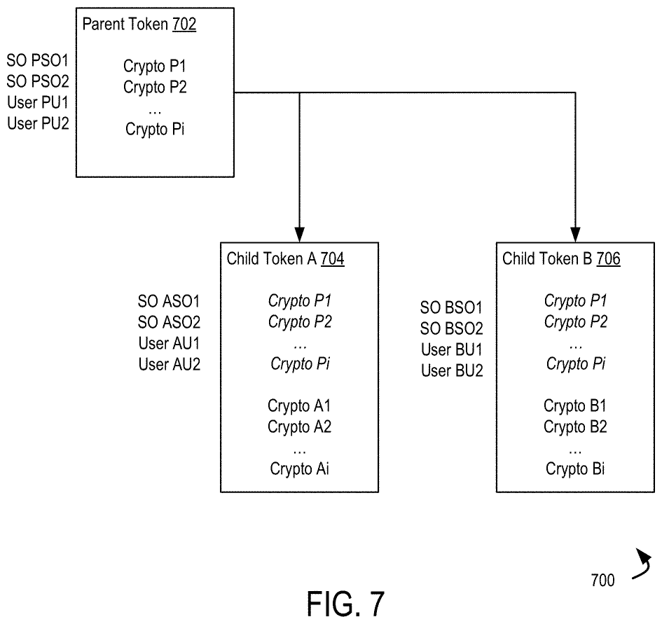

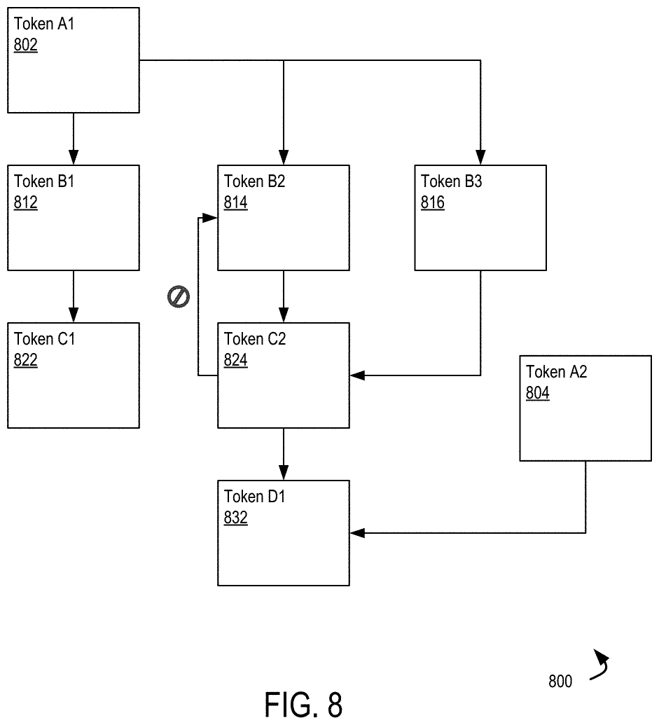

Examples of arrangements utilizing multiple parent tokens, as well as illustrating use of different security contexts, are discussed in detail below in conjunction with FIGS. 7-8.

### B. Methods of Managing Hierarchical Tokens

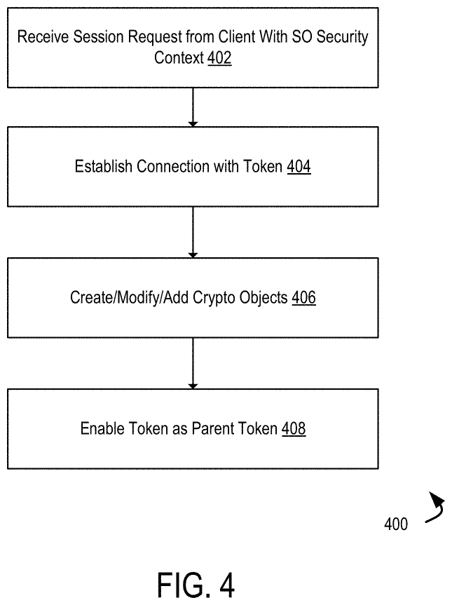

Referring now to FIGS. 4-6, example methods of managing hierarchical arrangements of tokens within a hardware security module, such as HSM 102 of FIG. 1, are described. For examples, the methods may be used to, for example, create, access, and define hierarchies among tokens stored in an HSM, according to embodiments of the present disclosure.

Referring first to FIG. 4, a flowchart of a method 400 for accessing and establishing inheritance of a parent token by a first entity, in accordance with aspects of the present disclosure. In this example, the first entity may be a “parent” entity, e.g., an entity associated with or controlling cryptographic objects that may be shared across client/customer tokens of a plurality of other entities.

In the example shown, the method 400 includes receiving a session request from a client device (step 402). The session request with the HSM (e.g., HSM 102) is made by a particular client, for example using client credentials to form a secured connection to the HSM. The session request is also associated with a particular security context that allows a user within that session to control inheritance of cryptographic objects associated with a token of that particular client. In a particular example, a “security officer” security context is required to adjust inheritance of cryptographic objects within a token owned/controlled by that particular client. In alternative examples, other security contexts (e.g., a user security context) could be used to adjust inheritance rights for at least some cryptographic objects associated with that token.

In the example shown, a connection is established with a token associated with (e.g., owned by or containing cryptographic objects of) the particular client (step 404). The connection allows the particular client to make the token available for, e.g., its cryptographic objects to be inherited by a token of another entity. At this point, the particular client may optionally add, edit, or otherwise modify cryptographic objects that are held within the token (step 406). This may be either to add or remove a particular cryptographic object, to modify or replace a particular object (e.g., in the event of key rotation or other periodic key replacement for security purposes).

In the example shown, the particular user associated with the token may designate that token as available for use as a parent token (step 408). This designation generally can include changing a property of the token to designate that token, as a whole, as available to act as a parent token relative to other tokens, including tokens associated with the same client/customer and other clients/customers. In some embodiments, designating a token as available for use as a parent token requires the client/customer to establish a session with the HSM as a security officer associated with that token that will act as a parent token.

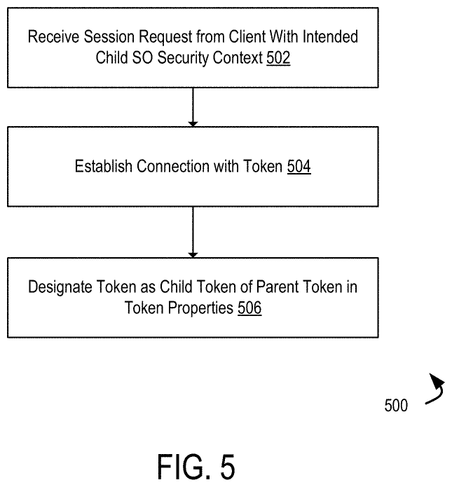

As discussed in further detail below, this designation of a token as being available to act as a parent token is generally insufficient to establish a parent-child or inheritance relationship among tokens. Rather, further linking must be performed at least with respect to the token that will act as the child token (as discussed below in conjunction with FIG. 5) in which a client/customer associated with that would-be child token designates the parent token as acting as a parent token within properties of the child token.

Additionally, because the above property described in a parent token does not specifically designate the related child token, in some embodiments where security contexts of the parent and child tokens are not identical, additional operations may be required by a security officer role of a customer associated with the parent token. For example, the security officer may be required to explicitly allow the parent/child relationship with the token designating the parent as its parent token. This may be accomplished by including a specific property within the parent token identifying the child token as a child of that parent token, either before or after the child token identifies the parent token as being a parent token.

It is noted that each of the properties described above, i.e., the property defining the parent token as being available to act as a parent (in step 408, above) as well as properties specifically identifying the parent token at the child token and vice versa, would be managed strictly within the HSM, and under control of a security officer role of the relevant token (e.g., the parent token for properties maintained within the parent token and the child token for identifications of one or more tokens acting as parent tokens to that child token).

FIG. 5 is a flowchart of a method 500 for accessing and establishing inheritance of a parent token at a client token by a second entity, in accordance with aspects of the present disclosure. The second entity may be a different entity than the one performing the method 400, for example a different client/customer using the HSM to establish a token of that client/customer as a child token that is to inherit cryptographic objects from one or more parent tokens, such as the parent token established using the method 400 described above.

In the example shown, the method 500 includes receiving, at a HSM (e.g., HSM 102 of FIG. 1), a session request to connect to the HSM and access a token stored therein (step 502). In example methods, the session request is received from a client/customer device that is associated with a token that the client/customer wishes to establish as a child token. The session request can be made with an associated security context that would allow that client/customer to establish a token as a child token. In an example embodiment, the session request is made with a security officer security context. Other security contexts are possible as well.

In the example shown, the method 500 includes establishing a connection with a token that is specific to that client/customer (step 504). The connection can be, for example, a secure session established between the client/customer and the HSM using a particular security context (e.g., a security officer context). Once such a connection, or session, is established, with any associated security context that is required to establish the connection, the client/customer may designate an accessed token as a child token of another token that was previously designated as available to be used as a parent token (e.g., via the method 400 described above).

In the example shown, the method 500 includes designating the token accessed by the client/customer as a child token of a selected parent token (step 506). The parent token may be the token described in connection with the method 400 of FIG. 4, which is designated as available to be a parent token. Designating the token as a child token may include identifying in properties of the child token that it is a child token of a particular, identified parent token. This may require that the session established to designate the token as a child token has a security officer security context that is associated with the child client/customer.

As noted above, at this point, if the client/customer designating the token as a child token has an identical security context as the context used to establish the parent token, no further action is required to establish the parent-child relationship between the tokens. However, if there is any difference in the security context between the two different entities or connections, a further operation may be required by the customer who is the owner of the parent token, e.g., to perform an analogous designation operation relative to the child token. That is, the parent token owner may specifically be required to identify the child token in properties of the parent token where different security contexts are used by the respective parent and child token owners.

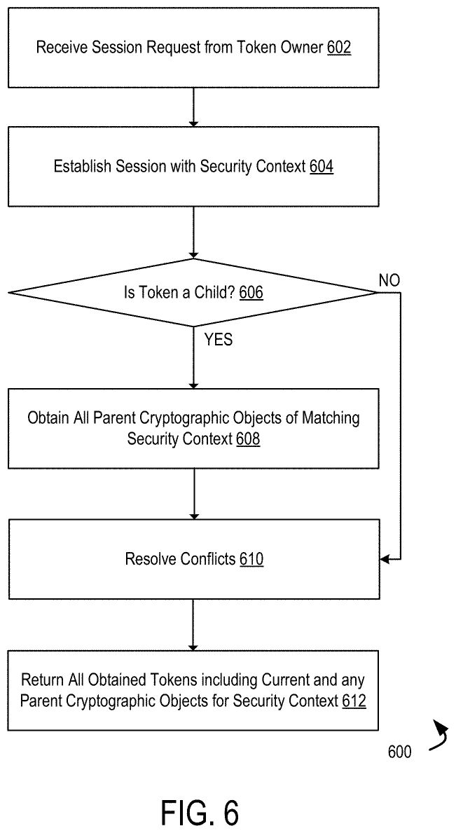

Referring now to FIG. 6, a method 600 for accessing cryptographic objects by an entity associated with a child token is disclosed, in which inherited parent cryptographic objects are accessed. The method 600 may be performed, for example, by a client/customer associated with a token established as a child token relative to one or more other tokens as discussed above.

In the example shown, the method 600 includes receiving a session request from an owner of a child token (step 602). The owner of the child token may establish a session to the HSM using a particular security context (e.g., as a security officer, user, public, or other custom role), e.g., with credentials that correspond to the particular security context (step 604). Accordingly, the owner of that child token may establish a session that allows that owner to access the child token, including cryptographic objects included in that child token that match the security context used for such access.

If the token is determined to be a child token relative to one or more other tokens (operation 606), all parent cryptographic objects having a common security context are obtained from parent tokens (step 608). For example, if a client/customer accesses the child token as a security officer, those cryptographic objects associated with that security context from the child token would normally be returned; in this operation, cryptographic objects from any parent tokens having a same security context would be returned. Notably, those cryptographic objects from a parent token that is linked to the child token having a different security context would not be accessible by that client/customer despite the linking of the parent token, in the same way cryptographic objects of the child having a different security context would remain inaccessible.

It is noted that the determination of whether a token is a child token, and return of cryptographic objects from any parent tokens, may be performed either all at once or in an iterative manner, in which cryptographic objects may be first retrieved from a parent, and then the parent assessed to determine whether it in turn is a child of any parent tokens for purposes of cryptographic object inheritance. In any event, step 608 generally completes upon traversing an entire inheritance tree of one or more parent/related tokens and return of any appropriate cryptographic objects for the current security context of the child seeking access to such objects.

In the example shown, any conflicts among cryptographic objects that are made accessible to the child token owner are resolved (step 610). Generally, it is noted that two keys that may be used for the same purpose may be stored in a child token and a related parent token. Or, a child token may be associated with two parent tokens that have analogous cryptographic objects. Other conflict scenarios may exist as well. In accordance with the present disclosure, a set of predefined rules may be applied to resolve any conflicts among such objects. These rules may be set at the HSM generally, or may be set specific to each child token and defined in parameters stored in the child token. Example rules may adopt all cryptographic objects of the child token over duplicate/analogous cryptographic objects of the parent token. Alternatively, cryptographic objects of one parent token may take precedence over duplicate/analogous cryptographic objects of another parent token, e.g., based on order of association with a given client, age, “closeness” of relationship to a child token (e.g., parent vs. grandparent, or other similar attenuated relationship), or other factors.

In the example shown, once all cryptographic objects are obtained and conflicts resolved, all obtained cryptographic objects, including those of the current client token (i.e., the child token) and any parent tokens, that are associated with a security context that matches the current client/customer's session type with the HSM may be returned for use by that client/customer (step 612). Accordingly, the client/customer may access only those cryptographic objects that (1) are anywhere within an inheritance chain associated with that client/customer's child token and any related parent tokens, (2) are of a same type of security context of the session used by that client/customer, and (3) do not violate any conflicts rules (e.g., by being a duplicate or different version of a cryptographic object already provided).

### C. Hierarchical Token Inheritance

Referring to FIGS. 7-8, schematic diagrams illustrating inheritance of cryptographic objects among tokens within a memory of a hardware security module (e.g., HSM 102 of FIG. 1) are shown. FIG. 7 shows a specific arrangement of a system 700 in which a parent token 702 contains cryptographic objects inherited by two different child tokens 704, 706.

In the example system 700 as shown, the parent token 702 has a plurality of cryptographic objects (Crypto P1, Crypto P2, etc.) and may be accessed using any of a number of security contexts. In this example, two different security officer contexts, SO PSO1 and SO PSO2, are shown, and two different user security contexts, User PU1 and User PU2 are established with the token 702.

Each child token 704, 706 is also established as having a plurality of its own cryptographic objects. In the example shown, token 704, referred to as Child Token A, may have cryptographic objects Crypto A1, Crypto A2, and so on. Token 706, referred to as Child Token B, may have cryptographic objects Crypto B1, Crypto B2, and so on. Similarly, each of tokens 704, 706 may be accessible using different security contexts. In the illustration shown, token 704 may be accessed using two different security officer contexts, SO ASO1 and SO AS02, and two different user security contexts, User AU1 and User AU2. Similarly, Token 706 may be accessed using two different security officer contexts, SO BSO1 and SO B502, and two different user security contexts, User BU1 and User BU2.

In this arrangement, establishing tokens 704, 706 as child tokens of parent token 702 may involve identifying the parent token 702 as available to act as a parent token using an attribute of that parent token, as discussed above in conjunction with FIG. 4. Subsequently, a session established with token 704 (by Client “A”, associated with Child Token A) may be used to link that as a child token of token 702, and a second session established with token 706 (by Client “B”, associated with Child Token B) may be used to link that as a child token of token 702 as well, e.g., using the method described above in conjunction with FIG. 5. Optionally, and depending on the security contexts used for the sessions used to connect to tokens 702, 704, 706 for purposes of establishing the parent/child relationship, either during the original session with token 702 establishing that token as a parent token or during a subsequent session (e.g., after tokens 704, 706 are established as child tokens), the token 702 may specifically be linked to the child tokens, as noted above in conjunction with FIGS. 4-5.

As illustrated, each of tokens 704, 706 inherits each of the cryptographic objects of the parent token 702. Accordingly, objects Crypto P1, Crypto P2, etc. appear to be a part of each child token 704, 706, respectively. Using this example, a user associated with a child token may establish a session connection with the HSM using a particular security context. For purposes of illustration, User A may access the HSM using a security officer context. That user may access only those cryptographic objects that are included in the child token and accessible to a security officer, and those cryptographic objects of the parent token 702 that would be available from the same-type session with the parent token (e.g., a security officer session). It follows that any cryptographic objects that would not be accessible in the parent token using that same session type would be inaccessible via the child token.

It is noted that in tokens, each cryptographic object may have a number of associated attributes and usages. For example, each cryptographic object mat be designatable as being modifiable, deletable, or extractable. Other vendor-defined attributes may be provided as well. In this inheritance context, each attribute that could compromise security of a parent cryptographic object by way of its access from a child token is set to be “false”. In other words, even if the cryptographic object is defined in the parent token as being modifiable, deletable, or extractable by a client directly accessing that parent token (i.e., the parent entity itself, using an appropriate parent security context), any access by way of a child token would result in the cryptographic objects being considered not modifiable, deletable, or extractable. Accordingly, while a client application, such as key management software, with an active session on a child token, may see specific cryptographic objects, that client application may not modify, delete, or wrap any objects inherited from a parent token. Regarding other vendor-defined attributes, additional rules may be provided that define whether parent object attributes carry through when inherited by a child token or whether, for security or consistency reasons, the child attributes would be defined differently.

Additionally, as noted above in FIG. 6 (at step 610), when cryptographic objects of token 702 are inherited by one of tokens 704-706, any conflicts among the cryptographic objects may result in a predefined rule to be applied. For example, a conflict may arise where a cryptographic object in toke 702 has a same label as an object in one of the tokens 704, 706. In that instance, for example, a rule may be defined indicating that the child token's cryptographic object having the same label overrides the parent cryptographic object, and the parent cryptographic object is consequently inaccessible from the child token.

In some embodiments, inheritance is limited to a single parent token. This may be enforced by the HSM overall, or may be enforced at the token level by setting a property of the token that defines whether the token is allowed to, e.g., have more than one parent token, or act as a parent token itself.

However, FIG. 8 illustrates a system 800 that illustrates an alternative embodiment in which multiple inheritance possibilities among cryptographic tokens are established. As noted above, properties of each token may be set to allow for a token's properties to be inherited by more than one child token. Similarly, a token designated as a parent token may also act as a child token. Also, a child token may define more than one parent token.

The system 800 illustrates such possibilities. Specifically, a token 802 (Token A1) may be defined as available to act as a parent token, and associated with each of tokens 812, 814, and 816 respectively (Tokens B1, B2, B3) using the methods described above in conjunction with FIGS. 4-5. Additionally, token 812 may be defined as a parent token relative to token 822 (Token C1), and tokens 814, 816 may both be designated as parent tokens relative to token 824 (Token C2). A still further token 832 may be designated as a child token of token 824, as well as a still further token 804 (Token A2) that is not otherwise affiliated with the token chain.

In this context, the HSM may enforce, either through properties of the tokens themselves or by way of management rules, additional conflict resolution processes among inherited cryptographic objects. For example, in some embodiments, as discussed above, a predefined ordering or set of rules for conflict resolution may be defined at the HSM. In alternative embodiments, the owner of the child token can configure properties of that child token that set an order of resolution (e.g., a priority order) of parent tokens for purposes of conflict resolution, with a highest-priority token being given precedence for its object to be inherited where multiple inherited objects with the same label would otherwise be inherited from different parent tokens. In some cases, rights to configure such properties may be restricted to a security owner security context of the child token.

Additionally, in example implementations, each parent token may be treated, for conflict resolution purposes, as intrinsically including any cryptographic objects that parent token has in turn inherited from a grandparent token (e.g., those objects inherited by token 814 from token 802, when considering conflict resolution among objects inherited from tokens 814, 816 at token 824). Other manners of treating inheritance (e.g., requiring a definition of prioritization of each parent and all tokens more than one generation removed from the child token) may be used as well, although additional complexity in terms of overhead and possible inheritance inconsistencies may be introduced.

As a particular limitation to the multi-inheritance arrangement seen in system 800, for inheritance consistency purposes, it is noted that a token may not be a parent token relative to any token that falls within its parental lineage. Accordingly, as shown in FIG. 8, an HSM will disallow defining token 824 (Token C2) as a parent of token 814 (Token B2) if that token was already defined as a parent of token 824. Similar, token 824 could not be defined as a parent of tokens 816 (Token B3) or 802 (Token A1).

Additional variations may be applied to the cryptographic object inheritance rules defined above in FIGS. 4-6 and as discussed in conjunction with the examples of FIGS. 7-8. For example, in some instances, particular cryptographic objects may be identified as not inheritable, using attributes stored with that cryptographic object in its respective token. Accordingly, such cryptographic objects may be accessible by direct access using an appropriate security context of that token's owner, but would not be accessible by a client/customer associated with a child token that would otherwise inherit that cryptographic object. The “inheritable” attribute associated with each cryptographic object could be accessed and assessed at a time inherited cryptographic objects are gathered for use by a child client (e.g., at step 608 of FIG. 6) to control whether such cryptographic objects are returned. In some embodiments, creation of cryptographic objects may result in this “inheritance” attribute being either enabled or disabled by default. In alternative embodiments, an HSM may enforce rules regarding access of cryptographic objects that do not have an inheritance attribute, or for which no value is set for such an attribute (e.g., defaulting to allowing or disallowing access to those cryptographic objects from child tokens).

Referring to the arrangements of FIGS. 7-8 generally, it is noted that in circumstances where a child inherits cryptographic objects of a parent token, a variety of rules may be enforced at the HSM to define when changes to parent cryptographic objects appear or are otherwise made available at the child token. In one possible embodiment, any changes, deletions, or additions to inherited cryptographic objects are immediately propagated to an active child token session. In an alternative possible embodiment, no changes are propagated to the active child token session; rather, a “snapshot” of the state of the parent token at the time the child token session is instantiated is taken, and does not change through the lifetime of the child token session. In a further possible embodiment, a hybrid model of the two possible alternatives may be used in which cryptographic objects in active use within the child session are not affected by changes to the parent token, but calls to locate or “load” cryptographic objects will reflect a realtime state of any inherited objects.

Regarding each of the security context, inheritance, and conflict resolution rules above, it is noted that although such rules will typically be defined as properties of individual tokens (either parent or child tokens) and enforced by the HSM when providing access to a token as part of a session, other implementations may be used in which any one of those inheritance properties, security context controls, or conflict resolution orderings may be separately modified or overridden using policies that are defined at the HSM outside of properties of the individual tokens. Regardless, the HSM will have ultimate control over policies that are adopted on either a global or per-token basis.

As can be seen from FIGS. 1-8 generally, the cryptographic object inheritance among tokens that is provided herein has a number of advantages. For example, in some cases, client/customer time and effort to perform key rotation may be reduced by 20-50% due to the reduction in redundant key rotation steps that are eliminated by consolidating cryptographic objects in a single inheritable parent token. However, advantages of the present methods and systems are not limited to only reduced storage requirements (e.g., removing redundant storage of inherited objects) and reduced overhead when parent cryptographic objects are modified. The methods and systems described herein also significant flexibility with respect to controlling which cryptographic objects are inherited, and how such inheritance is applied, that may not be readily accomplished (or even tracked) in scenarios where all cryptographic objects are required to be physically present in each token.

### D. Example Computing Environment

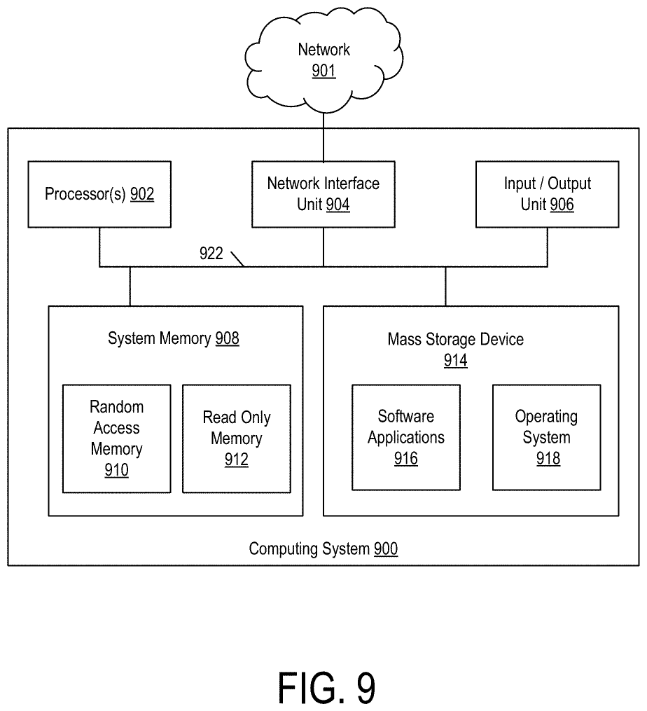

FIG. 9 illustrates an example block diagram of a virtual or physical computing system 900. One or more aspects of the computing system 900 can be used to implement the methods and system for hierarchical management of cryptographic objects within a hardware security module, store instructions described herein, and perform operations described herein. Although below a general-purpose computing system is described, it is recognized to a person of skill in the art that this system may be used to implement, at least in part, the hardware security module or client devices connecting thereto. If a hardware security module (HSM) is implemented, it is recognized that additional special-purpose hardware may be included beyond that which is shown, including, for example one or more special-purpose cryptographic processing circuits, tamper-evident/tamper-responsive features, encrypted storage, etc.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

### E. Methods of Controlling Delegation at an HSM Via Hierarchical Tokens

As illustrated above in connection with FIG. 1, tokens may be managed at an HSM 102 on behalf of clients 104 and/or secondary institutions 106. In some implementations, there may be a plurality of HSMs 102 included within a network. In such instances, two HSMs may establish a cryptographically secure communication channel, for example by a key certified by a security provider (e.g., the entity controlling one or both HSMs 102) and/or a customer 104. HSMs may include two or more physical HSMs, or a physical and a virtual (e.g., cloud based) HSM, across which keys may be shared.

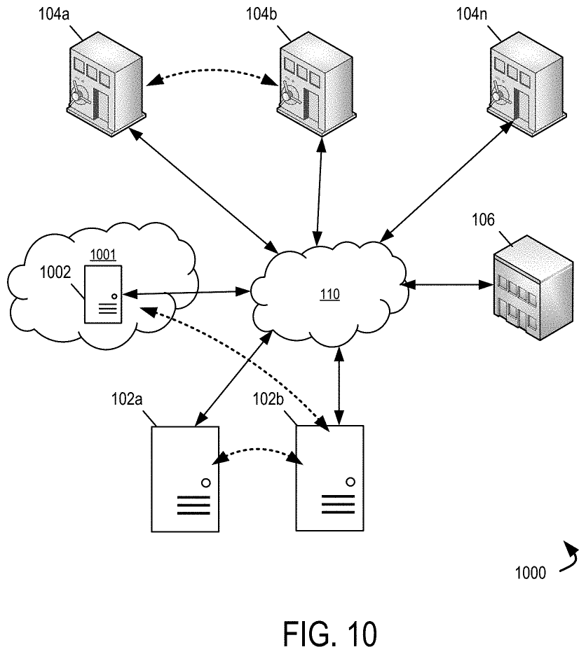

An alternative illustration of such a network is seen in FIG. 10. In this arrangement, a system 1000 may include a plurality of HSM's, shown as HSM's 102a-b. Additionally, a further HSM 1002, shown as a cloud-based HSM, may be implemented remotely, for example within a cloud provider 1001. The HSM's 102a-b and cloud HSM 1002 may be communicatively interconnected via a network 110, such as the Internet as described above. Otherwise, the implementation of the system 1000 may be analogous to that described above with respect to FIG. 1.

In the example shown, it may often be the case that keys are either generated at an HSM 102, 1002, or are generated by a customer and provided to one or more of the HSMs. In either instance, it may be the case that to devices, such as either HSMs 102, or devices at clients 104, may require trusted communication. In such instances, trusted communication may be managed using encryption keys which are managed by one or more of the HSM's 102, 1002. In existing systems, levels of trust are typically maintained within client applications executable at clients 104, so long as the endpoints are authorized to have access to a respective key used to access the application. That is, in many cases, an access control list may be provided to a client device or HSM alongside a key, with the access control list defining the entities and associated rights. Accordingly, the application that utilizes a given key is often tasked with managing access rights to particular functions or endpoints.

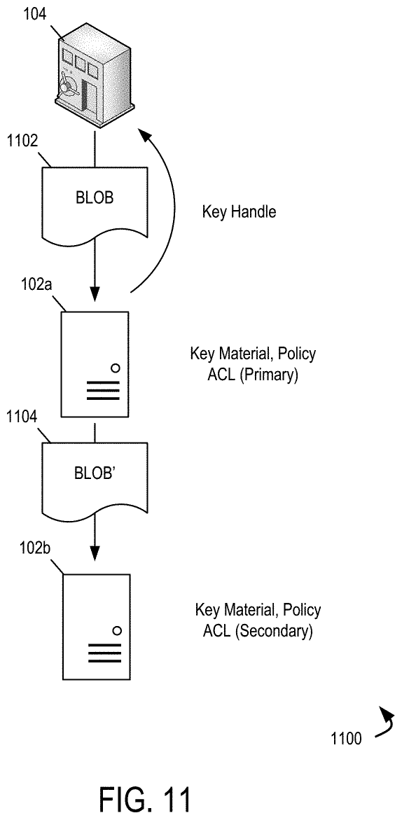

FIG. 11 shows an example sequence in which a key may be introduced into an enterprise infrastructure, and, by using the token hierarchy arrangements described herein, the key may be exchanged or passed with an adjusted set of access rights which are then enforced by the particular HSM managing a key used for a client application.

In this example 1100, a client 104 may use a client application, and communicate among other various client endpoints. The client 104 may have a key that the client wishes to use in association with the particular application. The client may supply the key to a HSM (e.g., HSM 102a) for storage and management. In the example shown, the key is provided to the HSM 102 in the form of a key blob 1102, which includes the key material as well as a policy controlling its use. In some examples, the policy may be implemented as an access control list (ACL).

When the HSM 102a receives the key blob 1102, that HSM 102a may decrypt the key blob, and store the key alongside the policy within the HSM, for example as part of a token. The HSM 102a will provide the client 104 a handle, which allows the client 104 to subsequently use the key. In this way, a key and policy may be managed at a particular HSM.

In some examples, a key may be migrated from a particular HSM, such as HSM 102a, to another HSM, such as HSM 102b. Although shown as migrating between two similarly situated HSM's, it is recognized that migration of a key may be between a physical HSM and a cloud-based HSM, such as HSM 1002 described above. Additionally, the key may, instead of being migrated between HSMs, simply be inherited by another token within the same HSM, where the child token may be used to enforce a limited set of inherited policy rights defined by that limited inheritance.

In traditional examples, to migrate a key among HSMs, HSM 102a would regenerate a blob such as key blob 1102 by encrypting a key and policy for transmission to another HSM, e.g., HSM 102b. Specifically, HSM 102a would utilize existing access control list programming features of creating a key blob, creating an archived key blob (e.g., for creating such a key blob from a received key, as in the key blob 1102) and sending a key blob. Such functions are performed using a known, existing access control list language. However, in accordance with the present disclosure, key blob creation and exchange processes may be modified to allow modification of a policy when that policy is sent in a key blob to another entity, such as for use in another token, or for migration to another HSM. In the migration example shown, a second key blob 1104 is created at HSM 102a which has a modified policy associated with it. The modified policy may represent a change in access rights defined in the policy (e.g., in the access control list) associated with the key. The second key blob 1104 may be provided to another HSM 102b, which may decrypt and store the key and modified policy. Client devices, such as client 104, may then request a key from the HSM 102b thereafter. In this way, a modified policy may be managed by a HSM (in this case, HSM 102b) rather than requiring management of compliance with any limitations on an access control list to be enforced by an application being executed at a client 104. This simplifies administration of such limited-rights policies and centralizes control over policy rights limitations that may be applied.

Specifically, to allow modification of a policy for purposes of migrating keys among HSMs and/or tokens, modifications to access control list programming may be made. By way of illustration below, modifications to the key blob creation, archiving, and sending processes may be implemented to allow for modifications of policy rights in inherited keys at the time of migration. For example, a typical action of sending a key over a secure communication session between HSMs may be defined as follows:

| Act SendKey =48 | |
|---|---|
| Details | |
| bitmap: | flags |
| ?rm | [remote module is provided] |
| optional: RemoteModule | rm [describes the peer] |

Accordingly, a remote peer HSM may be defined as a destination for the particular key blob to be sent to the remote destination, but no further details are defined in such a function. However, in a modified version of the access control list programming illustrated below, an additional optional field allows definition of a particular access control list that will be associated with the key for encryption and transmission. Specifically, such an action of sending a key with a modified policy may be defined as follows:

| Act SendKey =48 | |
|---|---|
| Details | |
| bitmap: | flags |
| ?rm | [remote module is provided] |
| ?acl | [ACL is provided] |
| optional: RemoteModule | rm [describes the peer] |
| optional: ACL | acl [ACL to send with key] |

Notably, in this example, not only is the remote module defined, but the particular access control list to be associated with a key may be defined. This has the advantageous effect of allowing a user to associate any policy, defined via an access control list, with the key. The selected access control list passed with the key may grant more, or fewer, rights as compared to the policy originally ascribed to the key. Therefore, inherited keys may have easily modified policies which are then enforced at the inheriting device (e.g., an inheriting HSM, such as HSM 102b of FIG. 11) rather than at an application level at a client device. Such client devices may further limit policy rights at the time of exchange of access control lists, so this would represent a maximum set of rights associated with a key/application.

Although the above example describes a change in policy at a time of sending a key, it is noted that such policy changes are not necessarily limited to such a send key operation. For example, similar modifications to access control list programming may be made with respect to other policy defining actions, such as a MakeBlob action or a MakeArchiveBlob action (e.g. at the time an application or HSM is used to migrate or exchange a key with another entity). In both instances, and addition of an access control list identifier allows modification of the policy associated with a key for the recipient of the key blob.

Accordingly, in accordance with the illustration described above, in some example implementations of the present disclosure, a key belonging to one token may be made available to another token, with a restriction on a particular policy associated with the token, applied via a token hierarchy, controlling its use. In accordance with the present disclosure, such restrictions may be extended to exchange of modified (e.g., typically limited) access control lists. The modified access control list would then result in the HSM enforcing the limited rights defined by a change between an original and any inherited access control list. Notably, the access control list that is exchanged represents a “maximum” access control list that is controlled by the HSM; the access control list may be further limited by reducing the access controls provided in such an access control list when subsequently exchanged, with such subsequent modifications of an access control list being controlled by an associated client application.

In particular example applications, such key delegation processes may be used to restrict rights, for example to control MAC key management. A child token may inherit rights to perform verification operations, but would not be able to perform creation operations.

In a further example, an organization may wish to control keys while performing cryptographic operations using those keys while maintaining keys on HSM hardware controlled by third parties, such as cloud service providers. In such a system, it is desirable that the HSM controlling party may only perform a limited set of operations with a key. By controlling the rights passed to such a third-party HSM, any application level vulnerabilities or platform level vulnerabilities may be avoided, since the HSM would only have access to the limited set of operations defined at the time of key delegation to that third party HSM.

In a still further example, an organization may wish to define a hierarchy of HSM operations, in which a parent HSM is permitted to perform key management operations and transmission to child HSM's (e.g., as in the role of HSM 102a described above), and child HSM's may be granted the ability to perform cryptographic operations with the key (e.g., as in the role of HSM 102b as described above).

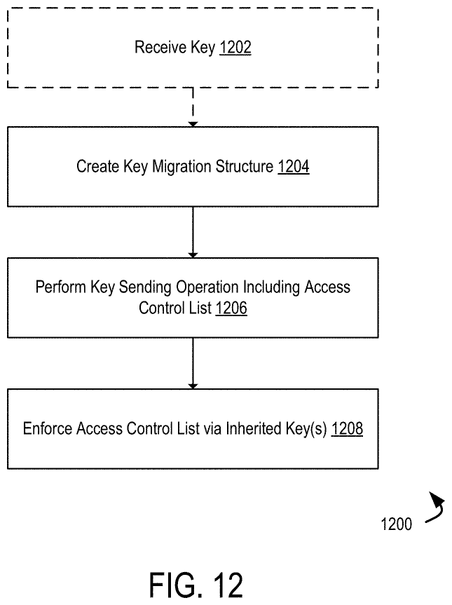

An example method 1200 of implementing this HSM-based policy enforcement is described in conjunction with FIG. 12. In the example shown, the method 1200 may optionally include receipt of a key at an authorized entity, such as an HSM (step 1202). Receipt of a key may include, for example, receiving a key blob from an application for management at the entity or HSM.

At some point, the entity managing a token that includes the key may wish to delegate certain functions to another token or entity. Accordingly, the entity, such as an HSM, may create a key migration structure (step 1204), and perform a key sending operation that includes a particular policy intended to be inherited (step 1206). The key migration structure may correspond, for example, to a key blob that is created using a send key operation such as that described above. The key sending operation may include identifying a particular access control list or other policy modification that will change the relative policy rights of the recipient of the key blob relative to the sending entity. Accordingly, a receiving entity, upon decrypting the key blob and registering the key (e.g. in a subsequent or child HSM) will enforce the inherited policy via the inherited key (step 1208). As noted above, this allows for creation of a parent child relationship among HSM's that will allow for policy modification and management at the time of delegation, and without requiring further management by an application that utilizes the key and policy. Additional advantages are realized, as reflected herein and in the following claims.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of particular inheritance relationships among tokens at an HSM using attributes of the tokens themselves, similar technologies may be used for managing hierarchical or inheritance-based relationships among tokens by maintaining such inheritance relationships separate or apart from the token storage themselves, e.g., for security enhancement.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A system for managing a cryptographic token hierarchy within a hardware security module (HSM), the system comprising:
a parent cryptographic token containing a plurality of parent cryptographic objects;
a child cryptographic token containing a plurality of child cryptographic objects, the child cryptographic token being associated with the parent cryptographic token;
wherein a session established with the child token provides access to at least some of the plurality of child cryptographic objects and at least some the plurality of parent cryptographic objects.

2. The system of claim 1, further comprising a second child token associated with the parent cryptographic token, the second child token containing a second plurality of child cryptographic objects.

3. The system of claim 2, wherein a session established with the second child token provides access to at least some of the second plurality of child cryptographic objects and at least some the plurality of parent cryptographic objects.

4. The system of claim 3, wherein the plurality of child cryptographic objects of the child cryptographic token are inaccessible via the session established with the second child token.

5. The system of claim 2, further comprising:
a second parent cryptographic token containing a second plurality of patent cryptographic objects; and
a third child cryptographic token containing a third plurality of child cryptographic objects, the third child cryptographic token being associated with the second parent cryptographic token.

6. The system of claim 5, wherein the parent cryptographic token is associated with a first service bureau, the child cryptographic token is associated with a first card issuing institution, and the second child cryptographic token is associated with a second card issuing institution different from the first card issuing institution.

7. The system of claim 1, wherein the parent token is a separate token from the child token within the hardware security module.

8. A method of managing tokens used at a hardware security module, the method comprising:
receiving a session connection request from a client associated with a child token, the child token containing a plurality of child cryptographic objects;
in response to the session connection request, establishing a session with the child token, thereby providing access, via the session, to at least some of the plurality of child cryptographic objects and one or more parent cryptographic objects contained within a parent token associated with the child token.

9. The method of claim 8, wherein the session has a security context, and wherein the at least some of the plurality of child cryptographic objects is associated with the security context.

10. The method of claim 9, wherein at least one child cryptographic object is included in the child token that is not associated with the security context, the at least one child cryptographic object being inaccessible via the session.

11. The method of claim 10, wherein the one or more parent cryptographic objects are associated with the security context of the session, and at least one parent cryptographic object included in the parent token other than the one or more parent cryptographic objects is not associated with the security context and therefore inaccessible via the session.

12. The method of claim 8, further comprising:
receiving a second session connection request from a second client associated with a second child token, the second child token containing a second plurality of child cryptographic objects, the second client being unaffiliated with the client;
in response to the second session connection request, establishing a session with the second child token, thereby providing access, via the session, to at least some of the second plurality of child cryptographic objects and the one or more parent cryptographic objects contained within the parent token, the parent token being associated with both the child token and the second child token.

13. The method of claim 8, further comprising, at the hardware security module:
receiving a second session connection request from a second client associated with the parent token, the session request being associated with a security context associated with a security officer associated with the parent token; and
within a session established with the parent token in response to the second session connection request, receiving authorization from the second client to authorize inheritance of the one or more parent cryptographic objects of the parent token by one or more child tokens.

14. The method of claim 13, further comprising, at the hardware security module:
receiving a session connection request associated with the child token, the session request being associated with a security context associated with a security officer associated with the child token; and
within a session established with the child token in response to the second session connection request, receiving authorization to associate the child token with the parent token.

15. The method of claim 8, wherein the parent token is not modifiable from within the session established with the child token.

16. The method of claim 8, wherein changes to the parent token made concurrently with an active session with the child token are accessible during the active session.

17. A system comprising:
a parent cryptographic token stored in memory of a hardware security module (HSM), the parent cryptographic token containing a plurality of parent cryptographic objects;
a child cryptographic token stored in the memory, the child cryptographic token being associated with the parent cryptographic token and containing a plurality of child cryptographic objects;
wherein a session established with the child token provides access to at least some of the plurality of child cryptographic objects and at least some the plurality of parent cryptographic objects.

18. The system of claim 17, further comprising:
a grandchild cryptographic token stored in the memory, the grandchild cryptographic token being associated with the child cryptographic token and containing a plurality of grandchild cryptographic objects;
wherein a session established with the grandchild token provides access to one or more of the plurality of grandchild cryptographic objects, one or more of the plurality of child cryptographic objects, and one or more of the plurality of parent cryptographic objects.

19. The system of claim 18, further comprising a second child cryptographic token stored in the memory, the second child cryptographic token being associated with the parent cryptographic token and containing a second plurality of child cryptographic objects;
wherein the grandchild cryptographic token is associated with both the child cryptographic token and the second child cryptographic token.

20. The system of claim 18, wherein a modification of one or more of the plurality of parent cryptographic objects is accessible via a session with any one of the child cryptographic token, the second child cryptographic token, or the grandchild cryptographic token.

21. A system for managing a policy associated with a cryptographic object within a hardware security module (HSM), the system comprising:
a processing device;
a memory operatively connected to the processing device and storing instructions which, when executed, cause the processing device to:
generate a key blob associated with a key managed within the hardware security module, wherein, at the hardware security module, the key is associated with a policy comprising an access control list; and
send the key blob to an inheriting hardware security module securely connected to the hardware security module via a key sending operation;
wherein the key sending operation includes an identification of a second access control list different from the access control list, the second access control list defining a policy associated with the key at the inheriting hardware security module.

22. The system of claim 21, further comprising receiving, at the hardware security module a key blob including the key and the policy.

23. The system of claim 22, wherein the key and policy are stored within a token at the inheriting hardware security module.

24. The system of claim 23, wherein a session established with the token at the inheriting hardware security module provides access to the key in accordance with an inherited policy defined by the second access control list.
